(19) United States
(12) Patent Application Publication
(10) Pub. No.: US 2023/0073968 A1
(43) Pub. Date: Mar. 9, 2023

(54) ONLINE LICENSING PLATFORM COMPRISING COORDINATED USE OF ONLINE-VIEWABLE TEAM ROSTER AND LINKED MICRO BLOG

(71) Applicant: James E. BEECHAM, West Palm Beach, FL (US)

(72) Inventor: James E. BEECHAM, West Palm Beach, FL (US)

(21) Appl. No.: 17/882,870

(22) Filed: Aug. 8, 2022

Related U.S. Application Data
(63) Continuation-in-part of application No. 17/470,193, filed on Sep. 9, 2021, now abandoned.
Application No. 17/470,193 is a continuation-in-part of application No. 17/582,875, filed on Jan. 24, 2022, now abandoned.
Application No. 17/582,875 is a continuation-in-part of application No. 17/825,917, filed on May 26, 2022.
Application No. 17/825,917 is a continuation-in-part of application No. 17/844,221, filed on Jun. 20, 2022.

(51) Int. Cl. G06Q 50/00; G06Q 30/06

(52) U.S. Cl. CPC G06Q 50/01; G06Q 30/0601; G06Q 2220/18

(57) ABSTRACT

The present invention comprises online licensing platform comprising linked micro blog component comprising means for user sports fan to view tag-identified postings by other users including online licensing platform-registered amateur athlete posting on micro blog, User is further allowed to interact with said platform's online-viewable team roster in making contemporaneous purchase of license from at least one of: an athlete listed on said roster, a plurality of athletes each listed on said roster. Said micro blog comprising sequence of tags attached by posting-user to his input of post to micro blog, said tags as means for designating storage of post as linked to a specific community within micro blog. Said micro blog further comprising view of said post from feed of said community, said view allowed by access granted to viewing-user who selects sequence of tags matching the input-tags selected by posting-user.

### CROSS-REFERENCE TO RELATED APPLICATIONS

The present application is a continuation in part application to U.S. Non-Provisional application Ser. No. 17/470,193 filed 9 Sep. 2021 entitled ‘METHOD AND SYSTEM FOR SPORTS ATHLETE SELLING USE-OF-NAME LICENSE TO FAN TO ENABLE DISPLAY OF SAID ATHLETE NAME IN AD ENDORSEMENT OF TEAM SPIRITEDNESS OF SAID FAN ON SAID FAN SOCIAL MEDIA PAGE’, and to non-provisional application Ser. No. 17/582,875 filed 24 Jan. 2022 entitled ‘ONLINE LICENSING PLATFORM WITH ADDITIONAL FEATURES’, and to non-provisional application Ser. No. 17/825,917 filed 26 May 2022 entitled ‘ONLINE LICENSING PLATFORM COMPRISING PRE-AUTHORIZATION BLOCK, RATINGS OF ATHLETES’ PLATFORM-RELATED ACTIVITIES, LINK TO VIEW AMATEUR ATHLETE ONLINE SOCIAL MEDIA POSTS, AND LIVE STREAMING′, and to non-provisional application Ser. No. 17/844,221 filed 20 Jun. 2022 entitled A COMPUTERIZED SYSTEM AND METHOD FOR IMPROVING EFFICIENCY OF SALE AND PURCHASE OF NAME, IMAGE AND LIKENESS (NIL) LICENSES, the disclosures of which are hereby incorporated in their entirety at least by reference.

### BACKGROUND OF THE INVENTION

### 1. Field of the Invention

The present invention generally relates to micro blog system. More specifically, instant invention comprises coordinated use within online licensing platform of online-viewable team roster and linked micro blog.

### 2. Description of Related Art

Prior art may include US 20200019912 by Tilton, 20160196590 A1 by Morgan, 20130246633 A1 by Giesen, and 20190220882 A1 by Fojtik.

### BRIEF SUMMARY OF THE INVENTION

One embodiment of present invention comprises online licensing platform comprising local computer system configured to enable a fan to access an online licensing platform via the Internet, wherein said local computer system comprises computational hardware. In a preferred embodiment, said computational hardware comprises means for presentation to at least one user of at least one team roster viewable on said licensing platform, said roster comprising use by at least one sports fan in fan's designation of purchase within platform.

In a preferred embodiment, said computational hardware and associated software comprise means for at least one designation of purchase of name, image, likeness (NIL) use license from amateur athlete by said user. said designating linked to said user's online use of an online-viewable team roster. In a preferred embodiment, said computational hardware comprises a said online licensing platform configured to connect said fan with at least one athlete listed within said at least one online-viewable team roster, said connection comprising fan conveying money to said athlete at least contemporaneous to said fan receiving license rights.

In a preferred embodiment, said computational hardware further comprises a said online licensing platform configured to enable a conveyance of money to at least one amateur athlete, said conveyance linked to online-viewable team-roster comprising in said roster a listing of said athlete. In a preferred embodiment, said money is transferred from said online-roster-viewing fan at least contemporaneous to conveyance via said platform of licensing rights to said fan who designates purchase by said fan's click on said online-viewable team roster screen.

In a preferred embodiment, said computational hardware further comprises a said online licensing platform comprising means for said fan to designate at least contemporaneous conveyance of money to each of a plurality of athletes, said plurality of athletes each listed on at least one online-viewable team roster of said online licensing platform. In a preferred embodiment, said computational hardware further comprises means for a said online licensing platform to host coach-hosted events and/or contests comprising fan participation. In a preferred embodiment, said computational hardware further comprises means for user to request platform administration to add a specific city listing and/or a specific sport's name listing to said online licensing platform.

In a preferred embodiment, said computational hardware further comprises means for a posting of social media content on linked micro blog by a posting-user of system. In a preferred embodiment, said computational hardware further comprises a means for one user to follow platform posts by another platform user within said linked micro blog. In a preferred embodiment, said computational hardware further comprises means for at least one user of said online licensing platform to follow online posts within tag-designated community of said linked micro blog.

In a preferred embodiment, said computational hardware further comprises means within online licensing platform for posts authored by platform-registered group comprised of athletes and sports fans to be shared in tag-designated community of said linked micro blog. In a preferred embodiment, said computational hardware further comprises means for said community group's designated tags to comprise at least one tag of geography name and at least one tag of sport name.

As background regarding micro blog, with development of network techniques, micro-blogs have become an important platform for users to communicate with each other and present themselves. Users may acquire information of interest by searching micro-blogs.

Generally, in a traditional micro-blog sorting method, micro-blogs are sorted based on a timeline, such as micro-blog posts more recently made being sorted closer to the top of the feed. In the traditional micro-blog sorting method, all micro-blogs of all users are mixed, and typically sorted based on the timeline of receipt, which mixing and sorting resulting in users having to spend significant effort and time to find the micro-blog posts related to themselves and/or of interest to themselves, as opposed to the many posts not of interest within a busy and complicated micro-blog.

As background, other sorting methods for micro blogs have been disclosed. For example, U.S. Pat. No. 9,785,677 to Ma, the publication thereof incorporated herein in its entirety at least by reference, discloses a method comprising: acquiring micro-blog information requested by a micro-blog requesting user; extracting micro-blog posting user information and content information from the micro-blog information to score the micro-blog information; sorting the micro-blog information according to the score; and presenting the micro-blog information according to a sorted result.

In instant invention, a preferred embodiment is disclosed as online licensing platform comprising linked micro blog component, said method and system comprising means for user sports fan to view tag-identified postings by amateur athlete on micro blog, and further to interact with said platform's online-viewable team roster to purchase a license from said athlete. Said micro blog comprising tags attached by posting-users onto their posts at input, said tags designating community within micro blog for storing said posts, and said micro blog further comprising matching tags selected by viewing-user to allow said viewing-user access to feed of said tagged and input posts from said designated community comprising said stored posts.

In instant invention, a preferred embodiment is disclosed as a novel method and system of sorting micro blogs, as herein described. Instant invention preferred embodiment micro blog method and system comprises tag-defined social media communities wherein user can, for example, post in a user-selected first community, then user can take feed of posts from same general subject at different level of specificity by user selecting second tag set, as further disclosed herein. Furthermore, instant invention method and system preferred embodiment comprises coordinated link of a first user's activities on micro blog component of instant invention to corresponding same user's activities within licensing component of instant invention, as further disclosed herein.

As background, prior art comprises means to create a feed of content items to be shared within a network of social-networking communities. For example, U.S. Pat. No. 11,392,961 to Karelin discloses a computer system including a processor and a memory storing control logic for causing the processor to create a feed of content items to be shared within a network of social-networking communities. The publication U.S. Pat. No. 11,392,961 is incorporated herein in its entirety at least by reference.

Briefly, instant invention preferred embodiment comprises a system for users to make and share posts with other users on social media, said system comprising a processor and a memory storing control logic for causing the processor to create a feed of content items to be shared within a subset of users of social-networking communities, the control logic comprising: first computer-readable program code for processing a plurality of posting-user member's choices expressed by said posting-user's designation of tags on system specifying storage of at least one of his posts as linked to a first community; second computer-readable program code for causing the processor to create a feed generated to comprise directing said at least one post to system storage, said storage comprising link to said designated first community; third computer-readable program code for causing the processor to provide a webpage receiving said first designated community's feed of said stored post, the website comprising access to said post for system users who have designated on system a set of tags matching those tags selected by said posting-user in directing his said post to said storage.

In a preferred embodiment, the means for accomplishing said system comprises user selecting preferences from a tag-screen (see FIGS. 4 and 7, 8). In a preferred embodiment, a tag-screen is used by posting-user for designating first community as his intended site for storage of his next post. In a preferred embodiment, tag-screen is used by viewing-user for designating said first community for feed of posts to view.

Said choices by users of tags at ‘input and output’, as chosen from tag-screens, comprise means for system to firstly accept and store posts from posting-user as applicable to a specified community, to secondly store said posts in memory linked to a posting-user designated community, and to thirdly configure a feed comprising said posts to view of viewing-user who chooses corresponding tags. Illustrated herein are an example of tag-screen used by posting-user (see FIG. 7) for his choices, and an example of tag-screen used by viewing-user (see FIG. 4) for her choices.

Although similar in some ways to commonly applied hashtag-based systems, such as Twitter or Instagram hashtags for example, the instant invention tag-screen system has key differences from common hashtag systems. For example, with instant invention, the user's choices from Tag-screens are typically made from list of choices supplied by site administration. Thus, there is no issue with hashtags selected/authored directly by users leading to banned tags. Also, with issue selection in instant invention there is typically only one tag allowed to specify an ‘issue’ (see FIG. 8 at ‘issue’), and thus there is no risk of spamming restriction from excess number of post-associated hashtags.

By comparison, other systems' hashtags tend to be heterogenous and sometimes confusing due to lack of specificity as to relationship one hashtag subject or meaning to the other hashtag subject or meaning. Instant invention tags are herein disclosed as arranged logically into stepwise communities. Said stepwise communities are tag-named in manner sufficient to allow user to have at least an opportunity for at-a-glance accurate impression of the true relationship of one post community to the next community of posts, since the arrangement and naming of communities within instant invention micro blog comprises a logical stepwise progression as to of subject matter. This logical progressive arrangement of visible tag designations allows posting-user to efficiently react regarding content posting, i.e., to choose an appropriate community more consistently for placing or assigning a specific post content. Furthermore, instant invention arrangement and tag-naming of communities within instant invention micro blog allows viewing-user to efficiently react regarding immediately understanding from said tag names on community search whereby viewing-user can efficiently arrange request for post feed to access viewing-user's desired content. In a preferred embodiment, instant invention logical progression of input sequence of tags on communities at multiple input levels allows for a coordinated and easily-understood-by-users' system of coordinated output tag sequence use in designation of multiple output feeds. Said visible tag organization helps users understand what type of posts to expect within the communities of a subject matter network. This logical expectation feature helps both posting-users and viewing-users in quick and accurate decision making for efficient use of instant invention system.

For example, the progression of tags in FIGS. 7 and 8 has capability to enable users to post and view in said respective subject matter communities. State of Florida high school basketball is an example of a first level of expected subject for posts, while State of Florida girls' high school basketball in Palm Beach County is instantly recognized by users as stepwise related but more narrowly focused subject for posts within the same general subject matter.

Furthermore, a posting-user within instant invention preferred embodiment, can designate one set of tags to input a post within instant invention, and said posting-user can swiftly then become a viewing-user of subject-related posts at a different level within the system, Such efficient switch can be achieved by user logic based on instant invention system organization.

User can understand the communities immediately at-a-glance due to logical arrangement of micro blog tags allocating system into stepwise communities. Said logical arrangement allowing user at least opportunity for at-a-glance correct impression as to suitability of a post for a specific tag-designated community, and at least allowing user at least opportunity for accurate at-a-glance impression of the relationship of content of a first stepwise level community feed content to the content of a second related stepwise level community feed within said same micro blog of subject matter within instant invention.

User can designate a set of tags to achieve the desired feed, based on system's promotion of user's intuitive understanding of the stepwise communities organization. This aspect will become clearer with discussion of figures below. User can, for example, post a comment linked to user-selection of tags specifying one city of a state's regarding college men's basketball activity, then user can easily switch to view next stepwise level of related posts feed by user-selection of tags specifying college men's basketball post feed regarding the entirety of same said state.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a schematic of preferred embodiment.

FIG. 2 is a schematic of preferred embodiment.

FIG. 3 is a schematic of preferred embodiment.

FIG. 4 is an illustration of webpage of preferred embodiment.

FIG. 5 is an illustration of webpage of preferred embodiment.

FIG. 6 is an illustration of webpage of preferred embodiment.

FIG. 7 is an illustration of webpage of preferred embodiment.

FIG. 8 is an illustration of webpage of preferred embodiment.

### DETAILED DESCRIPTION OF THE PREFERRED EMBODIMENT

The following description is provided to enable any person skilled in the art to make and use the invention and sets forth the best modes contemplated by the inventor of carrying out his invention. Various modifications, however, will remain readily apparent to those skilled in the art since the general principles of the present invention have been defined herein to specifically provide efficient online licensing platform comprising linked micro blog with means for coordinated use of online-viewable team roster.

The word “a” is defined to mean “at least one.” The word ‘efficiency’ is defined as ability to accomplish a job with relatively less expenditure of time and effort.

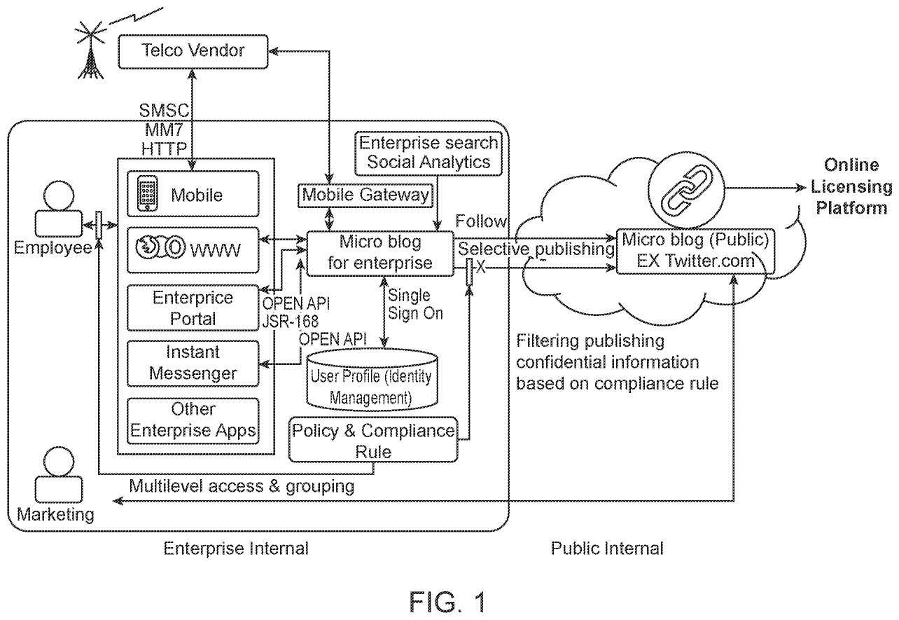

FIG. 1 is a schematic of preferred embodiment wherein a public-facing micro blog of Twitter®-style posts/tweets (left side of FIG. 1) comprises link to online licensing platform (right side of FIG. 1 near link symbol) of instant invention. The linked micro blog comprises a system comprising computational hardware and means for adding a series of community-specific tags to a first user's blog post at input, said tags providing means for directing storage of post within system to a first community, and allowing a second user to view the said post by selecting matching community tags within micro blog system. In FIG. 1, the architecture of preferred embodiment comprises a Telco vendor (top left) for two-way communication comprising use of mobile devices. A micro blog for enterprise has registered users able to sign on. The employee of the micro blog (middle left of FIG. 1) applies the policy and compliance rules (bottom, middle) in selective publishing of the user generated blog posts (tweets). Within the registered user base are users typically comprised of sports fans, coaches, and amateur athletes. Said users are accommodated on the micro blog component, and by the link (link indicated by joined rings symbol top right) can access the online licensing platform component. The system computational hardware and software provide means for users to follow (in the Twitter sense of following) posts on platform by other system users. Instant invention system further comprises sports fan view on licensing platform of team-roster-listed amateur athlete, such listing typically comprising athlete name and photo and data of athlete sports activities on team. System further comprises said sports fan, via use of said online-viewable team roster, allowed to designate and purchase at least one license offered by a team-roster-listed amateur athlete on said linked licensing platform. System further typically comprises ability of user of micro blog component to chat message with said team-roster-listed amateur athlete, such as contemporaneously to system user conveying money to said team-roster-listed athlete via use of online licensing platform.

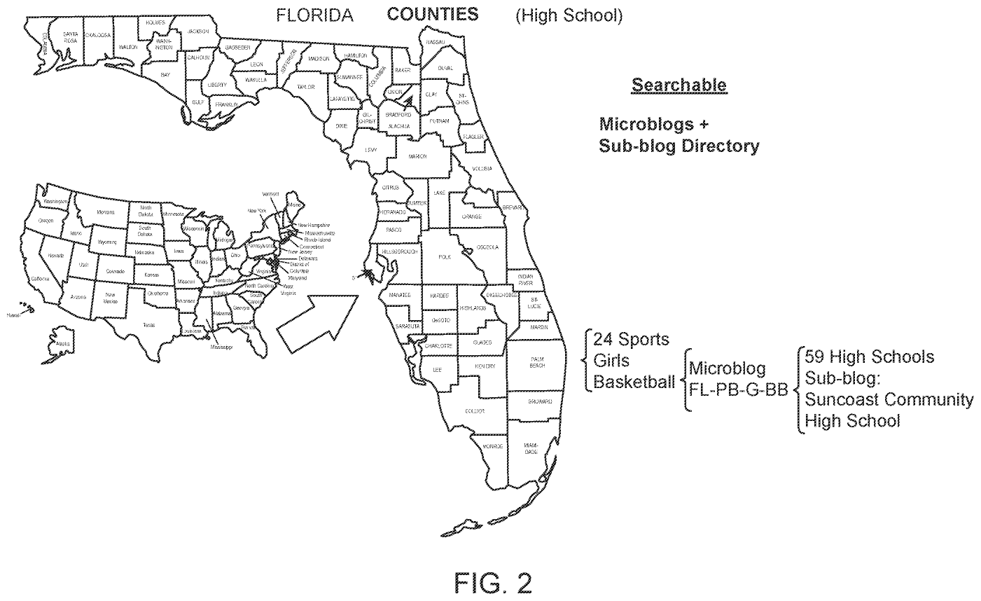

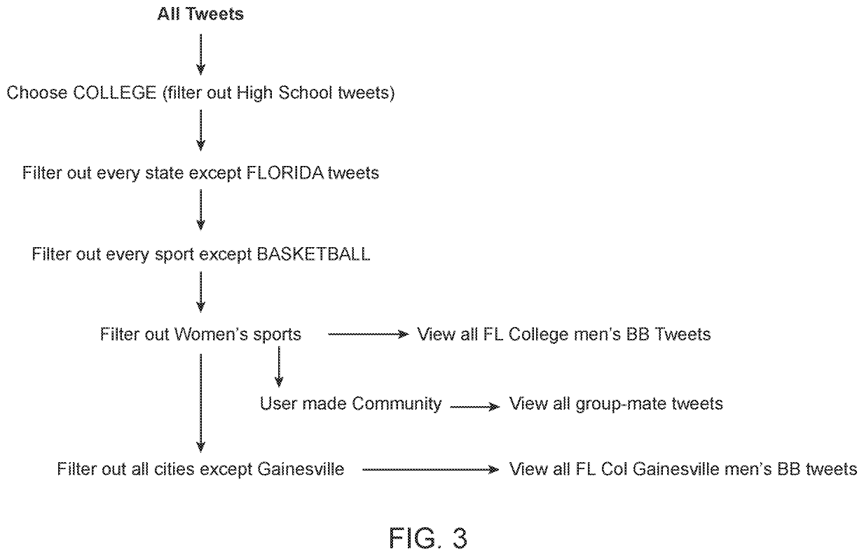

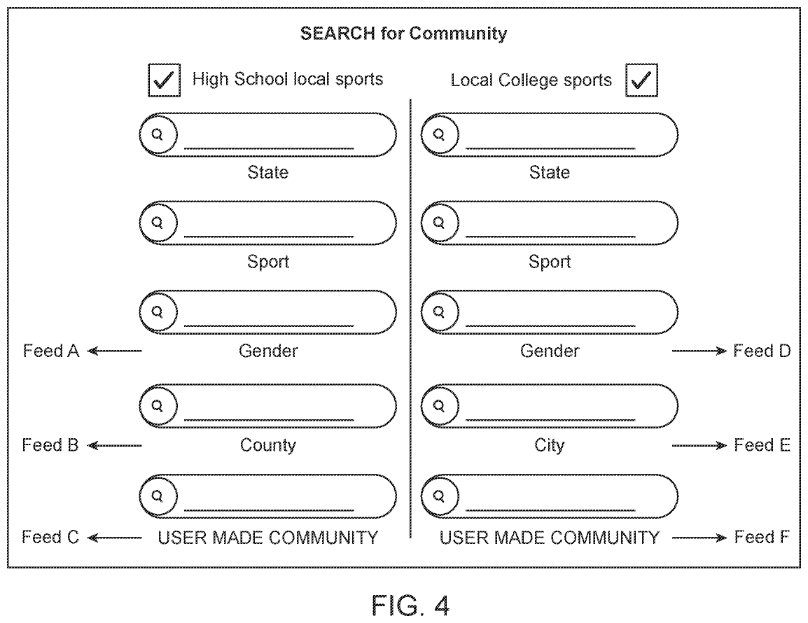

FIG. 2 is a schematic of preferred embodiment wherein the geographic representation of micro blog is illustrated as organized with a community specified by geographic name and sport name. System typically comprises tagging posts (tweets) of users on input side, such tagging optionally associating the post with said geographic context and said sport name context. For example, a map of the state of Florida herein depicts the counties of the state. The computational hardware and software of the system optionally provide the user means for selecting to tag a post during input with a tag of geography name, such as State of Florida, and a sport name/sport level/gender, such as girls' high school basketball. As further discussed for FIGS. 3 and 4 below, the posting-user's choice of tags typically determines the post storage as linked to designated community within micro blog. For example, as FIG. 2 illustrates, one possible set of tags comprises High School sports, State of Florida, Palm Beach County, Girls' Basketball. Such tag set renders the so-tagged post as assigned to the corresponding community within the system as illustrated by map. Such assignment of same tags on a plurality of posting-users' posts, allows system to comprise a blog community of posts (tweets). Such community is available to viewing-users as a feed of tagged posts (tweets) authored by said group of posting-users. Computational hardware and software provide means for such tagging and such storage and such feed arrangement, as further disclosed herein. In FIG. 2, bottom left, details of such microblog ‘HS-FL-PB-G-BB’ are understood to comprise the supply of posts (tweets) delivered to viewing-user who has designated to receive said ‘HS-FL-PB-G-BB’ feed. In this manner, a supply of posts by posting-users who tagged their posts for Florida, Palm Beach County, Girls' basketball (high school level) is delivered to a viewing-user who choose feed of corresponding tag sequence. There are 58 high schools in Palm Beach County, Fla. at the time of this writing, at least a plurality of these schools comprising a girls' basketball team. Therefore, those platform viewing-users having interest in the PB County geographic area and having interest in high school girls' basketball, such users are allowed by system to designate the feed of: ‘HS-FL-PB-G-BB’, as for example offered to them by Community Search screen, as further disclosed below (FIG. 4). As disclosed in FIG. 2, bottom left, system offers posting-users opportunity to form a community within the geographic/sports tag configuration of Palm Beach County, Fla. girls' high school basketball. For example, a posting-user is provided means by system computational hardware and software for selecting to further tag their ‘HS-FL-PB-G-BB’ posts with ‘Suncoast Community High School (SCCHS)’ as additional tag of user-made community. Such posting-user is provided means by system computational hardware and software to select to create online, within platform of instant invention, a community for other users to similarly tag and post comments. Such users thereby are sharing their online comments as related to Florida, Palm Beach County, girls' basketball pertaining to Suncoast Community High School. Said posts comprise each the input tag and output search specification of: ‘FL-PB-G-BB-SCCHS’.

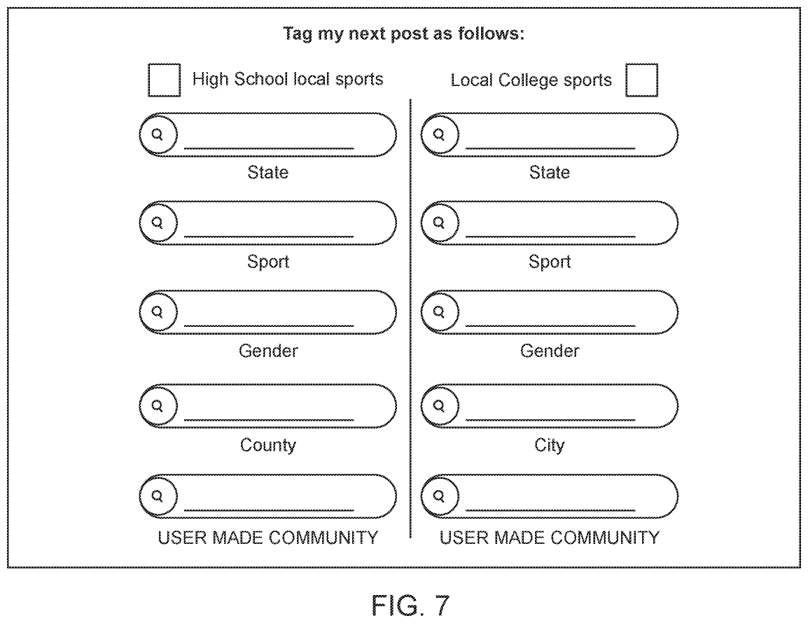

FIG. 3 is a schematic of preferred embodiment wherein tagging of posts (tweets) by posting-user and viewing-user is disclosed within the micro blog component of the instant invention online licensing platform. Said user choices are typically made on a tag-screen, such as one similar in appearance to the ‘Search for Community’ screen shown in FIG. 4 or one similar in appearance to the ‘Tag my posts’ screen shown in FIG. 7. The tag-screen typically comprises a set of choices for user to designate tags, such as tags by posting-user who wishes to apply the tags to his posts, or such as by viewing-user who wishes to designate a community from which to receive a feed of posts sent to said viewing-user on website. In FIG. 3, a posting-user opts for a college sport tag and a geographic location tag of State of Florida to be applied to his posts. As disclosed in FIG. 3, the ‘College’ tag is a means to tag a post inbound to the Community ‘FL-C-BB-M’, i.e., State of Florida-College-Basketball-Men's′. Such tags tend to in effect filter out from the community the High School sports posts. Then, as described, user designates a second tag for said ‘inbound’ posts, the tag representing State of Florida. Then, per FIG. 3, user designates a third tag, basketball. Then, per FIG. 3, user designates a fourth tag, sport by males. In this manner, instant invention preferred embodiment, comprising use of computational hardware and software, comprises means for posting-user's four choices of tags to classify his posts as inbound to storage linked to a community so-designated. Within the system, users with similar interests to said posting-user can comprise viewing-users who choose to view the feed of said FL-C-BB-M′ community of posts. As further disclosed in FIG. 3, a user can choose to create a community as a subset to the said FL-C-M-BB′ community. Typically, said creator of subset community is provided, by use of instant invention computational hardware and software, means for designating said subset and then receiving requests from system users wishing to join said subset community. As further disclosed in FIG. 3, user can add a further tag to his FL-C-BB-M′ post, a tag specifying Gainesville, a city in Florida where the University of Florida is headquartered. In this manner, a FL-C-BB-M-Gainesville′ designated post authored by said posting-user can contribute to a community of posts pertaining to Florida men's college basketball as related to Gainesville, Fla., said posts viewable by viewing-users who so designate with tags.

FIG. 4 is an illustration of webpage of preferred embodiment, wherein a user can input into a tag-screen, said tag-screen serving as Search for Community designator. The user's choices of tags indicate the community from which the viewing-user wishes to receive the feed. The webpage of FIG. 4 discloses a left side column of choices wherein a user can choose High School sports, and then enter subjacent fields of stepwise nature comprising tags from dropdown menus. For example, the user will click the word State, and the dropdown menu will display clickable choice on list of the 50 states. Similarly, the sport choice is clickable from a dropdown menu of more than 20 sports. Similarly, the user selects male or female gender as indication of gender of sport athlete activity in desired community of posts. Similarly, the user can select a county from dropdown menu of counties in said state. As indicated in FIG. 4, a community feed (Feed A) is available comprised of posts corresponding to viewing-user input posts of posting-user which were tagged: HS-Florida-Sport-specific Gender. This community could pertain, for example, to High school sports-related posts having to do with a specific Florida-based sport community by gender, such as Girls' gymnastics. As indicated in FIG. 4, a community feed (Feed B) is available comprised of posts by users entering tags: HS-Florida-Sport-Gender-County. This community could pertain, for example, to High school sports-related posts having to do with a specific Florida-based sport community by gender and county, such as Florida High School Girls' gymnastics in Palm Beach County. As disclosed in FIG. 4, a posting-user can add a 6^{th} choice as tag to post, the choice of creating a user-made community. For example, a user could create a community of coaches designated by tags: High School-Florida-girl's gymnastics-Palm Beach County-Coaches.

Furthermore, in FIG. 4, as disclosed in the right-side column, college sports-related posts can be sought by a viewing-user as a community by search, such searching user using four or five or six choices among designations: college, State, sport, gender (Feed D available), or further adding city (Feed E available), and further adding specific to comprise user-made community tag (Feed F available). Typically, a viewing-user can change feeds he receives at any time by changing viewing-user selections in the Search for Community tag-screen. In a preferred embodiment, instant invention allows comprising viewing-user designation of three tags, or four tags, or five tags, to respectively access a first feed of same subject area at a first specified stepwise level, a second feed of same subject area at second specified stepwise level, a third feed of same subject area at a third specified stepwise level.

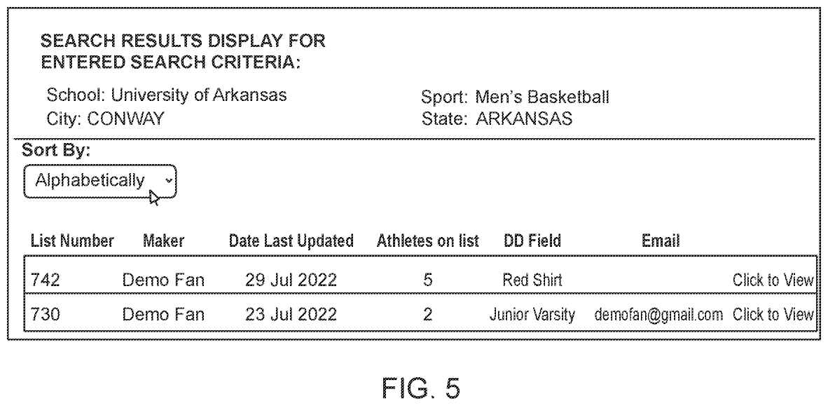

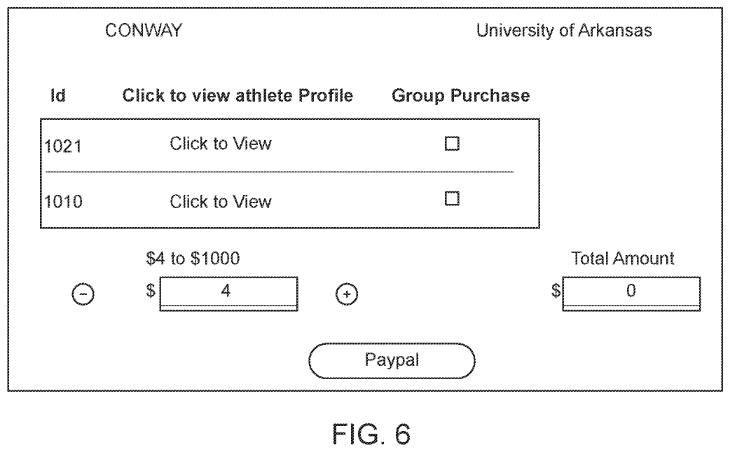

FIG. 5 is an illustration of webpage of preferred embodiment. In FIG. 5, Search results are displayed responsive to sports fan viewing-user search on tag-screen of Team Roster search of online licensing platform. The said user had there input team roster search criteria specifying University of Arkansas and city Conway, and sport of basketball, and gender of athlete as male. Two team rosters are displayed in list as found in said Search. As displayed in FIG. 5, Team Roster list #742 has 5 athletes on roster. User selects to view this #742 roster of 5 athletes. Said roster is displayed in FIG. 6. The user is interested to find an athlete whose posts user had previously read on micro blog linked to online licensing platform.

FIG. 6 is an illustration of webpage of preferred embodiment, wherein user views online-viewable team roster #742 in response to user selection in FIG. 5. Seen in FIG. 6 are a listing of the first two athletes of said roster, each being male and each a basketball player at University of Arkansas. Sports fan clicks the ‘click to view’ button in top line, that click corresponding to profile data of athlete #1021. System displays the profile of said athlete #1021 (profile not shown here). The profile provides fan a view of a photo of said athlete #1021 and a video of said athlete #1021, and other details including athlete's name and athlete's position and activities on said University of Arkansas basketball team. From this information, user concludes this athlete #1021 is the author of the posts user had read on the linked micro blog. Athlete #1021's profile on online licensing platform comprises a link to athlete #1021's blog posts (link not shown here). User viewing FIG. 6 decides to purchase a license from said athlete #1021 and also purchase a license from the athlete #1010, the athlete listed in FIG. 6 as below athlete #1021, i.e., user decides to make a group purchase. Said sports fan user's interest in athlete #1010 can be due to athlete #1021's recommendation posted in micro blog for fan to also support athlete #1010 (recommendation not shown here). Said sports fan user clicks the group purchase button of said each athlete listing in FIG. 6. Said sports fan clicks the plus sign button at price selector below, to increase the displayed price from $4 to $6. Said sports fan verifies that the Total Amount of group purchase is displayed correctly as $12 for the group purchase. Said sports fan clicks the ‘Paypal® button’ to make said simultaneous group purchase. Said group purchase, via instant invention online licensing platform interaction, conveys $12 as $6 from said sports fan to each of athlete #1021 and #1010. Said purchase contemporaneously conveys corresponding licensing rights to said purchasing sports fan.

FIG. 7 is an illustration of a webpage of a preferred embodiment wherein a tag-screen is shown suitable for use by posting-user to designate choices regarding into which community he wishes his next post (tweet) to be stored as linked. A posting-user who wishes his next post to be inserted into storage linked to a community of posts comprising news about High School athletics will indicate such by clicking the ‘High School local sports’ box at top left. Said posting-user who wishes to post said post as linked to feed regarding High School sports news pertaining to the State of Florida will further click the name Florida from the dropdown menu displayed for the category ‘State’. Said posting-user who wishes to post about Florida High School sports news pertaining to the sport basketball will further click the sport name basketball from the dropdown menu displayed for the category ‘Sport’. Said posting-user who wishes to post about Florida High School basketball news pertaining to girls' basketball will further click the gender of female from the dropdown menu displayed for the category ‘Gender’. A feed is thus made available for viewing-users corresponding to said sequence of choices. However, if the posting-user wishes to post regarding Florida High School girls' basketball news pertaining to Palm Beach County, said posting user can further click on Palm Beach County from dropdown list of counties to add PBC tag. A feed is made available for said sequence of tag choices ‘HS-FL-BB-F-PBC’. Furthermore, if the posting-user wishes to post regarding Florida High School girls' basketball news in Palm Beach County pertaining to Suncoast Community High School, said posting user can further enter that high school's name in the user-made community input and add that tag to make such feed available.

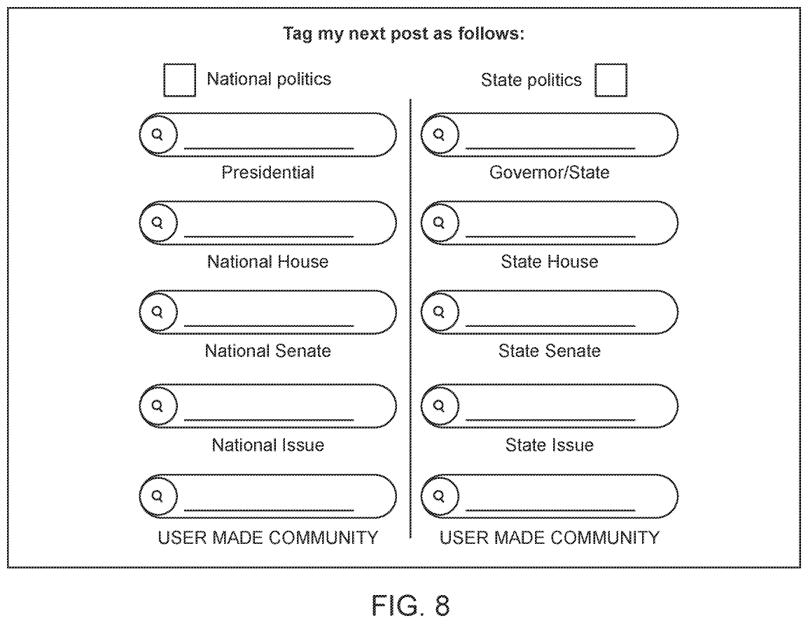

FIG. 8 is an illustration of a webpage of a preferred embodiment wherein a tag-screen comprises politics-related tag choices. Such choices allow posting-users to post into one or more of the progressively more narrowly focused stepwise communities related to tags displayed on screen. In a preferred embodiment, the progressive stepwise sequence of tags herein disclosed comprise means for assigning at input/or selecting for view, any of a related group of posts comprising similar subject matter as understood at-a-glance. As background, the laws pertaining to high school student-athletes' ability to legally receive payment for use of their name, image, and likeness (NIL) while retaining their amateur status, said laws are currently under discussion by politicians on state-by-state basis and nationally. Politics is therefore of interest to at least some amateur athletes, fans, and coaches. The instant invention system and method for micro blog linked to online licensing platform allows posting-users and viewing-users to add/view posts within the system, said posts of political context. For example, the tag-screen used by posting-user, as depicted in FIG. 8, has a fill-in at the bottom for ‘issue’. By entering ‘amateur athletics NIL’ in the ‘issue’ fill-in space and by further clicking the choice ‘State politics’ at top right, the posting-user is tagging his next post to be stored in computer memory with a link to a community of viewing-users who are interested in the politics of specified state regarding amateur athletics and NIL. Another option within the tag-screen is ‘Governor/State’ where posting-user can select from dropdown menu list of the 50 states to indicate his state. Other option within the tag-screen is ‘State House’ and/or ‘State senate’. The posting-user can thus tag his inbound posts to be assigned to corresponding level of political community wherein he wishes to comment. Similarly, a viewing-user with interest in same level of political community in regard to same issue of NIL can select feed by entering corresponding set of tags.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention

Reference to “first,” “second,” “third,” and so forth members throughout the disclosure (and in particular, claims) are not used to show a serial or numerical limitation but instead are used to distinguish or identify the various members of the group.

What is claimed is:

1. An online licensing platform comprising:
a local computer system configured to enable a fan to access said online licensing platform via the Internet, wherein said local computer system having computational hardware;
at least one team roster viewable on said licensing platform by at least one sports fan;
at least one designation of purchase by said fan, said designation linked to said fan's online interaction with said team roster; and wherein said computational hardware comprising a said online licensing platform configured to connect said fan with at least one athlete listed within said at least one team roster; and wherein said computational hardware comprising a said online licensing platform configured to enable a conveyance of money to said at least one team-roster-listed athlete contemporaneous to conveyance of licensing rights to said fan; and
a linked micro blog comprising use of selection of tags by a posting-user in assigning storage of post linked to a first community of said micro blog, a matching set of said tags allowing viewing-user to select feed of said same post from same micro blog community.

2. The online licensing platform of claim 1, further comprising said computational hardware comprising a said online licensing platform configured to enable said fan to designate conveyance of money contemporaneously to a plurality of athletes, each of said athletes listed on said team-roster.

3. The online licensing platform of claim 1, further comprising within said linked micro blog, means for making posts and sharing posts using a computer system comprising a processor and a memory storing control logic for causing the processor to create a feed of content items to be shared within a subset of users of social-networking communities.

4. The online licensing platform of claim 3, further comprising the said control logic comprising: first computer-readable program code for processing a plurality of posting-user member choices expressed by said posting-user's designation of tags on system specifying storage of at least one of his posts as linked to a first community.

5. The online licensing platform of claim 3, further comprising the said control logic further comprising second computer-readable program code for causing the processor to create a feed generated to comprise directing said at least one post to system storage, said storage comprising link to said designated first community.

6. The online licensing platform of claim 3, further comprising the said control logic further comprising third computer-readable code for causing the processor to provide a webpage receiving said first designated community's feed of said stored post.

7. The online licensing platform of claim 6, further comprising the said website comprising access to said post for system users who have designated on system a set of tags matching those tags selected by said posting-user in directing his said post to said storage.

8. The online licensing platform of claim 1, further comprising at least one user of said online licensing platform allowed to follow online posts within said platform, said followed posts comprising at least one post authored by an athlete listed in said online-viewable team roster.

9. The online licensing platform of claim 1, further comprising posts designated with tags of at least one of geographic context and sports name context.

10. A micro blog system comprising computational hardware and means for adding a series of community-specific tags to direct a first user's blog post to system storage linked to a first community of a micro blog network of communities, said tags providing means for a second user to view the post by viewing-user selecting corresponding tags for feed from said first community.

11. The micro blog system of claim 10, further comprising tags corresponding to geographic location and sport of interest.

12. The micro blog of claim 10, further comprising community of posts comprising searchable tags comprising at least one tag of list: High School, College, a State of the 50 USA states, a gender.

13. The micro blog of claim 10, further comprising link to online licensing platform comprising at least one viewable post by at least one sports fan purchaser of a license from an amateur athlete.

14. The micro blog of claim 10, further comprising linked online licensing platform, said micro blog comprising at least one post by an amateur athlete listed on team roster viewable on said licensing platform.

15. A computer system for making posts and sharing posts on social media, said computer system comprising a processor and a memory storing control logic for causing the processor to create a feed of content items to be shared within a subset of users of social-networking communities, the control logic comprising: first computer-readable program code for processing a plurality of posting-user member's choices expressed by said posting-user's designation of tags on system specifying storage of at least one of his posts as linked to a first community; second computer-readable program code for causing the processor to create a feed generated to comprise directing said at least one post to system storage, said storage comprising link to said designated first community; third computer-readable program code for causing the processor to provide a webpage receiving said first designated community's feed of said stored post, the website comprising access to said post for system users who have designated on system a set of tags matching those tags selected by said posting-user in directing his said post to said storage.

16. The system of claim 15, further comprising tag at least related to at least one of high school sport, college sport, state, city, county, a gender, National politics, State politics, President, Governor, Senate, House.

17. The system of claim 15, further comprising tags arranged logically into stepwise communities allowing user at least opportunity for at-a-glance correct impression as to suitability of a post for a community, and at least opportunity for accurate at-a-glance impression of the relationship of content of a first level community to the content of a second level community within micro blog system.

18. The system of claim 15, further comprising user designation of three tags to respectively access a first feed of same subject area at a first specified level, four tags to respectively access a first feed of same subject area at a second specified level, and five tags to access a first feed of same subject area at a third specified level.

19. The system of claim 15, further comprising logical progressive arrangement of visible tag designations allowing posting-user to efficiently post content to appropriate community befitting specific post content and further allowing viewing-user to efficiently arrange post feed to efficiently access his desired content.

20. The system of claim 15, further comprising use of online-viewable team roster comprising listing of amateur athletes, said use comprising group purchase of licenses from athletes listed in said licensing platform online-viewable team roster.
